(19) United States
(12) Patent Application Publication
(10) Pub. No.: US 2016/0316502 A1
(43) Pub. Date: Oct. 27, 2016

(54) Job Site Radio with Wireless Control

(71) Applicant: ROBERT BOSCH GMBH, Stuttgart (DE)

(72) Inventor: John DeCicco, Elmhurst, IL (US)

(73) Assignee: Robert Bosch GmbH, Stuttgart (DE)

(21) Appl. No.: 15/105,915

(22) PCT Filed: Dec. 22, 2014
(86) PCT No.: PCT/US2014/071851

§ 371 Date: Jun. 17, 2016

Related U.S. Application Data
(60) Provisional application No. 61/920,084, filed on Dec. 23, 2013.

(51) Int. Cl. H04W 76/02; H04N 21/81; H04N 21/422; H04N 21/63; H04N 21/4363; H04W 4/00; H04N 21/262

(52) U.S. Cl. CPC H04W 76/023; H04W 4/008; H04N 21/8113; H04N 21/26258; H04N 21/632; H04N 21/43637; H04N 21/42221; H04W 88/04

(57) ABSTRACT

A job site radio includes a wireless transceiver, such as a Bluetooth transceiver, that enables mobile electronic devices around the work site to stream digital music and other audio from the mobile electronic devices to the job site radio for playback. In one embodiment, the mobile electronic devices execute a software application to implement a remote control functionality for the job site radio. This increases the range typically associated with prior art infrared remote control devices, and enables workers to use a wide range of mobile electronic devices such as smartphones in conjunction with the job site radio instead of requiring a single-purpose remote control device.

### CLAIM OF PRIORITY

This application claims priority to U.S. Provisional Application No. 61/920,084, which is entitled “Job Site Radio With Wireless Control,” and was filed on Dec. 23, 2013, the entire contents of which are hereby incorporated by reference herein.

### TECHNICAL FIELD

This disclosure relates generally to radios, and, more particularly, to job site radios that interface with mobile electronic devices using a wireless communication protocol such as Bluetooth.

### BACKGROUND

Many job sites for construction or other commercial and industrial work include a group of workers who are present throughout the job site at any given time during the day. A job site radio can be used for entertainment or for distributing information throughout the job site. Since job sites can often be outdoors or in other rugged environments, the job site radio is typically encased in a durable enclosure that is optionally water proof or water resistant. Some radios offer a remote control, typically an infrared remote control, so that the radio functions can be controlled without having to physically handle the radio device itself. Some job site radios include physical connections, such as universal serial bus (USB) connections, for the physical connection of cell phones, media players, SD cards, and other forms of digital music media.

One disadvantage of all the existing radios is that the media device has to be physically connected to the job site radio. This is particularly disadvantageous of the digital media device is a cell phone as the worker then cannot conveniently receive calls if the worker is not standing next to the radio. Also, since the remote control included with the radio is infrared, range is rather limited. Therefore, most times the worker has to stop working and physically operate the controls on the radio in order to control operation of the radio to adjust the volume or station for playback. The remote controls that are included in many radios are inconvenient as the remote controls may be lost or damaged on the construction site. Consequently, improvements to job site radios that improve the flexibility of control and operation of the job site radios would be beneficial.

### SUMMARY

An audio playback device is embodied as a job site radio that includes a wireless transceiver, such as a Bluetooth transceiver, that enables mobile electronic devices around the work site to stream digital music and other audio from the mobile electronic devices to the job site radio for playback. In one embodiment, the mobile electronic devices execute a software application to implement remote control functionality for the job site radio. This increases the range typically associated with prior art infrared remote control devices, and enables workers to use a wide range of mobile electronic devices such as smartphones in conjunction with the job site radio instead of requiring a single-purpose remote control device.

In another embodiment, a method of operating an audio playback device has been developed. The method includes establishing with a wireless network transceiver in the audio playback device, a wireless network connection between the audio playback device and one mobile device in a plurality of mobile devices, receiving with the wireless network transceiver in the audio playback device a stream of data from a requested audio file stored in a memory of the one mobile device, generating with an audio output device in the audio playback device an audio output corresponding to the stream of data from the audio file, establishing with the wireless network transceiver in the audio playback device, another wireless network connection between the audio playback device and another mobile device in the plurality of mobile devices in response to a cessation of the stream of data from the audio file, receiving with the wireless network transceiver in the audio playback device another stream of data from another requested audio file stored in another memory of the other mobile device, and generating with the audio output device another audio output corresponding to the other stream of data from the other audio file.

In another embodiment, a method of operating an audio playback device has been developed. The method includes receiving with a wireless network transceiver in the audio playback device a first command from a first mobile device, receiving with the wireless network transceiver in the audio playback device a second command from a second mobile device, identifying with a controller in the audio playback device a first priority level of the first mobile device and a second priority level of the second mobile device, operating with a controller the audio playback device with reference to only the first command in response to the first priority level of the first mobile device exceeding the second priority level of the second mobile device, and operating with the controller the audio playback device with reference to only the second command in response to the second priority level of the second mobile device exceeding the first priority level of the first mobile device.

In another embodiment, an audio playback device has been developed. The device includes a wireless network transceiver configured to establish wireless network connections with a plurality of mobile devices, an audio output device, a memory, and a controller operatively connected to the wireless network transceiver, the audio output device, and the memory. The controller is configured to establish a wireless network connection between the audio playback device and one mobile device in the plurality of mobile devices with the wireless network transceiver, receive in the audio playback device a stream of data from a requested audio file stored in a memory of the one mobile device with the wireless network transceiver, generate an audio output corresponding to the stream of data from the audio file with the audio output device, establish another wireless network connection between the audio playback device and another mobile device in the plurality of mobile devices in response to a cessation of the stream of data from the audio file with the wireless network transceiver, receive another stream of data from another requested audio file stored in another memory of the other mobile device with the wireless network transceiver, and generate another audio output corresponding to the other stream of data from the other audio file with the audio output device.

### BRIEF DESCRIPTION OF THE DRAWINGS

FIG. 1 is a schematic diagram of a job site radio that is configured for operation in conjunction with a mobile electronic device through a wireless interface.

FIG. 2 is a schematic diagram of the job site radio from FIG. 1 in a configuration where the job site radio automatically retrieves audio data for playback from mobile devices that are present on the job site.

FIG. 3 is a block diagram of a process for controlling the operation of a job site radio using multiple mobile devices that are assigned different priority levels.

### DETAILED DESCRIPTION

For the purposes of promoting an understanding of the principles of the embodiments described herein, reference is now be made to the drawings and descriptions in the following written specification. No limitation to the scope of the subject matter is intended by the references. This patent also includes any alterations and modifications to the illustrated embodiments and includes further applications of the principles of the described embodiments as would normally occur to one skilled in the art to which this document pertains.

As used herein, the terms “mobile electronic device” and “mobile device” are used interchangeably and refer to any portable electronic device that includes a wireless network adapter, a processor, and a memory that is configured to store programmed instructions and one or more audio data files. Examples of mobile electronic devices include, but are not limited to, smartphones, tablet computing devices, wearable computing devices, and information systems that are integrated into motor vehicles. As described below, an audio playback system, such as a job site radio, enables multiple mobile electronic devices to provide sources of audio data for playback through the job site radio and to control the operation of the job site radio.

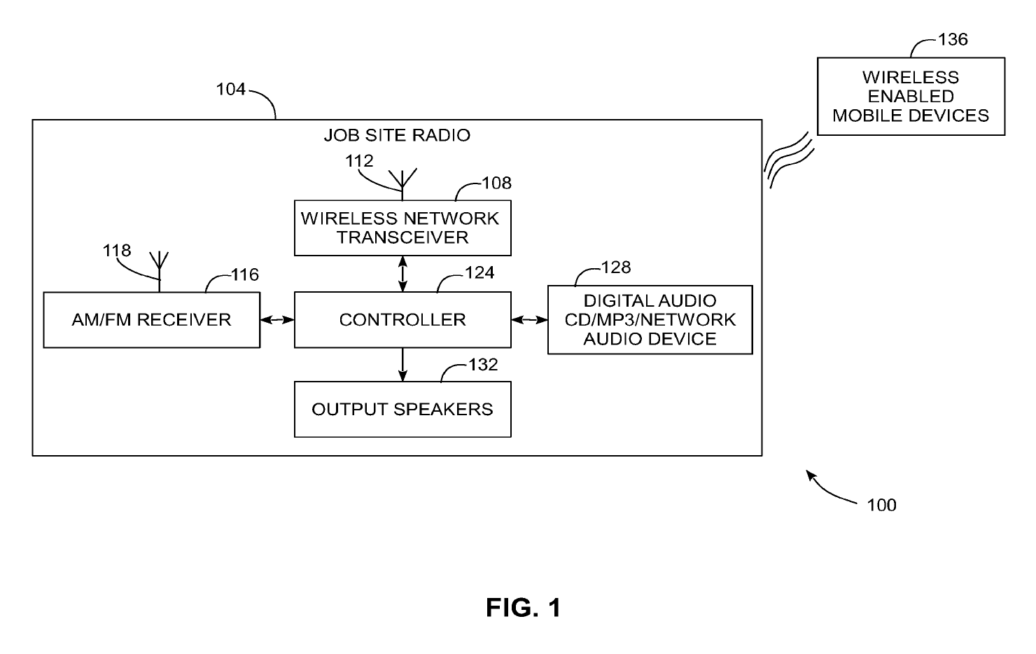

FIG. 1 depicts an audio playback system 100 that includes a job site radio 104 that communicates with a mobile device 136 using a wireless communication protocol, such as the Bluetooth protocol. The job site radio 104 is an audio playback device that includes a wireless network transceiver 108 with an antenna 110, an AM/FM radio receiver 116 with another antenna 118, a digital controller 124, an optional digital audio playback device such as a compact disc (CD), MP3 player, or data network audio streaming device 128, and audio output speakers 132. The mobile device 136 is a mobile electronic device such as a smartphone, tablet, notebook personal computer (PC), wearable computing device, and the like. In another embodiment, the mobile device 136 is an in-vehicle information system that is integrated into a vehicle present at the job site. The vehicle includes a Bluetooth, 802.11, or other suitable wireless transceiver that communicates with the job site radio 104. The mobile device 136 includes at least one wireless networking device that is configured to communicate with the wireless network transceiver 108 in the radio 104 to enable the mobile device 136 to control the operation of the job site radio 104, stream audio data to the job site radio 104 for playback, and to receive status data from the job site radio 104.

In one embodiment of the job site radio 104, the wireless network transceiver 108 is Bluetooth radio transceiver with an integrated radio frequency (RF) device that is configured to transmit and receive signals in an approved frequency band for the Bluetooth protocol, such as the 2.4 GHz Industrial, Scientific, and Medical (ISM) bands. In the embodiment of FIG. 1, the wireless network transceiver 108 is an LMX9838 Bluetooth transceiver module from Texas Instruments of Dallas, Tex. The Bluetooth transceiver is a universal asynchronous receiver/transmitter (UART) device that converts data that are received via the Bluetooth protocol into a serial communications protocol is provided to the controller 124. The controller 124 also sends serial data through the UART for transmission from the Bluetooth transceiver 108 to the mobile device 136. In the embodiment of FIG. 1, the Bluetooth transceiver 108 includes an integrated antenna 112, although alternative embodiments include separate antennas that are electrically connected to the Bluetooth transceiver. While the embodiment of FIG. 1 depicts a Bluetooth transceiver, alternative embodiments of wireless data transceivers and protocols include, but are not limited to, the 802.11 family of wireless local area network (WLAN) protocols and the wireless USB protocols for wireless data communication between the mobile electronic device 136 and the job site radio 104.

In the job site radio 104, the controller 124 is a microcontroller, microprocessor, digital signal processor, or any other suitable digital logic device that controls the operation any playback of audio in the job site radio 124. In the embodiment of FIG. 1, the controller 124 is operatively connected to the wireless network transceiver 108, AM/FM receiver 116, digital audio playback device 128, and audio output speakers 132 through one or more data connections. The radio 104 optionally includes an audio multiplexer that integrated with the controller 124 or operatively connected to the controller 124. The controller 124 operates the audio multiplexer to select a source of audio for output to the speakers 132 from the radio 116, digital playback device 128, or from the controller 124 in embodiments where the controller 124 decodes digital audio. The controller 124 includes one or more memory storage devices, such as a solid-state devices and random access memory (RAM) devices. The memory devices store programmed instructions for execution by the controller 124. The memory also stores registration data pertaining to one or more of the mobile devices 136 that are associated with the job site radio 104. The registration information optionally includes priority information that the job site radio 104 uses to determine which command to accept when the job site radio 104 receives commands and data from two or more of the mobile devices 136. In some embodiments, the memory in the job site radio 124 optionally stores digital audio files for playback.

In the embodiment of FIG. 1, the job site radio 104 includes an AM/FM receiver 116 with an associated antenna 118. In one embodiment, the AM/FM receiver 116 is a commercially available radio receiver that is well known to the art. The controller 124 controls the tuning of the AM/FM receiver 116 between the AM/FM bands and selection of frequency in the AM/FM bands. While FIG. 1 depicts an AM/FM radio 116, other embodiments of the job site radio 104 incorporate terrestrial digital radio receivers and satellite radio receivers.

The embodiment of FIG. 1, the job site radio 104 includes one or more optional digital audio playback devices 128. Examples of digital audio playback devices include, but are not limited to, compact disc (CD) players, digital audio players that play music and other audio stored on a data storage device, such as a solid-state memory device, and network streaming audio players that receive digital audio from an external data network such as the Internet. Examples of digital audio players include digital playback devices that decode audio from the MP3 format and from various other digital audio formats that are known to the art including, but not limited to, Ogg-Vorbis, AAC, WMA, and FLAC formats. Network streaming devices access an external data network through a wired or wireless data connection to receive audio data from one or more online music streaming services. As described below, in one operating mode the network streaming data are received from the controller 124 in a configuration where the mobile device 136 transmits a stream of audio data to the wireless network transceiver 108. The controller 124 directs the streaming audio data to the digital audio playback device 128 for decoding and playback through the audio output speakers 132.

During a streaming operation, the selection of music or other audio data that is transmitted from the mobile device 136 to the job site radio can be based on a predetermined playlist that is selected by the user based on the musical tastes of the user. In one configuration, the job site radio 104 uses the same playlists that are already present in the mobile device 136 for playback of music using a built-in audio playback program in the mobile device 136. If the user of the mobile device 136 updates the playlist, then the job site radio 104 automatically receives streaming audio corresponding to the updated playlist. In another embodiment, the user of the mobile device 136 selects radio stations in configurations of the mobile device 136 that include analog AM/FM or digital radio receivers or online musical streams from an online music streaming service. The job site radio 104 optionally receives the preferred radio station or streaming network service settings from the mobile device 136 and automatically tunes the radio receiver 116 or network audio device 128 to the same settings that are used in the mobile device 136. In this configuration, the job site radio 104 receives audio from the same preferred sources as are configured by the user of the mobile device 136, but does not have to stream the audio directly from the mobile device 136, which reduces the power usage requirements of the mobile device 136. The job site radio 104 receives updates from the mobile device 136 if the user of the mobile device 136 changes the preferred radio station or network audio stream, and the job site radio 104 uses the updated source of audio.

The job site radio 104 includes audio output speakers 132. In one embodiment, the audio output speakers 132 include one or more loudspeakers that are integrated into the housing of the job site radio 104. The audio output device 132 also includes filters, amplifiers, and other devices that enable generation of audio output through the speakers. The audio output speakers 132 optionally include output connectors for headphones or external speakers.

During operation, the mobile device 136 communicates with the wireless network transceiver 108 in the job site radio 104 to establish a “pairing” relationship that is commonly used with some wireless network devices, including Bluetooth devices. After completion of the pairing process, the mobile device 136 is used to control the operation of the job site radio 104, monitor the operating status of the job site radio 104, stream music or other audio to the job site radio 104 from a memory in the mobile device 136, and to transmit audio that is recorded from a microphone in the mobile device 136 to enable the job site radio to act as a loudspeaker for announcements.

In one mode of operation, the mobile electronic device 136 controls the operation of the job site radio 104. For example, in one embodiment a processor in the mobile electronic device 136 executes a software application that presents a graphical user interface (GUI) to a user. The GUI depicts if the job site radio 108 is tuned to the AM or FM band, the frequency of the radio, and a volume level of the job site radio 108. The user optionally enters input to adjust the band, frequency, and volume of the job site radio 108. The controller 124 receives the commands through the wireless network transceiver 108 and adjusts the operation of the AM/FM receiver 116 accordingly.

In another mode of operation, the mobile electronic device 136 displays a track number and optionally album name, song name, artist name, track length and progress, and digital album art to an end user when the job site radio 104 plays recorded music on a CD, digital MP3, or streamed from the Internet with the module 128. The mobile device 136 also presents a graphical user interface with controls to change the music track or adjust the volume of playback for any of the digital audio sources. The controller 124 receives the commands from the mobile device 136 through the wireless network transceiver 108 and adjusts the operation of the digital audio playback device 128 accordingly.

In another mode of operation, the mobile electronic device 136 streams audio data to the job site radio 104 for playback through the job site radio 104. Many mobile devices include a memory that stores digital audio data, and many mobile devices receive streaming audio through a wireless data network from online audio streaming services. A software application on the mobile device 136 generates a graphical user interface to enable selection of audio for streaming to the job site radio 104. The mobile device 136 transmits the digital audio data to the wireless network transceiver 108 in the job site radio 104. The controller 124 receives the digital audio data. In one embodiment, the controller 124 decodes the digital audio data for output to the audio output speakers 132. In another embodiment, the controller 124 directs the digital audio data to the digital audio playback device 128 and the digital audio playback device 128 subsequently decodes the streaming audio data for playback.

In another operating mode of the job site radio 104 that includes streaming audio from the mobile device 136, the job site radio 104 operates as a loudspeaker for verbal announcements from a supervisor or other job site employee who speaks into a microphone in the mobile device 136. As is known in the art, mobile devices such as smartphones include microphones for conducting phone calls and other audio recording purposes. Some models of other mobile devices including tablets and notebook computers also include microphones. In one embodiment, the software application on the mobile device 136 presents a “push to talk” or other graphical control to the user to activate and deactivate the loudspeaker functionality. The software application that is executed on the mobile device 136 is granted permission to access the microphone, and the software application encodes pulse code modulated (PCM) or other audio input data from the microphone into a compressed audio format that is transmitted to from the mobile device 136 to the wireless network transceiver 108 in the job site radio. The controller 124 then decodes the audio data and plays the audio through the audio output 132. The streaming audio process for loudspeaker announcements is similar to the streaming process for audio playback from music files that are stored in the mobile device 136, but the source of the audio is from the microphone in the mobile device 136.

In one embodiment, the activation of the loudspeaker functionality preempts the playback of audio from other sources, such as the radio receiver 116, digital playback device 128, or mobile device 136, and playback of the audio from the other sources resumes after the loudspeaker operating mode is deactivated. The controller 124 receives the audio data stream for the loudspeaker from the wireless network transceiver 108 that includes an identifier corresponding to a loudspeaker operating mode. The controller 124 pauses the playback of digital music from the digital music device 128 or deactivates the radio receiver 116 during the transmission of the streaming loudspeaker audio data from the mobile device 136. After termination of the audio stream, the controller 124 resumes playback of audio from the previously activated source. In a configuration where the previous audio source is streaming audio from the mobile device 136, the software application and the processor in the mobile device 136 deactivates the streaming of the music or other audio to enable streaming of the audio input through the microphone to the job site radio 104. Upon deactivation of the loudspeaker mode, the software application and processor in the mobile device 136 resume streaming of the audio data to the job site radio 104 for playback.

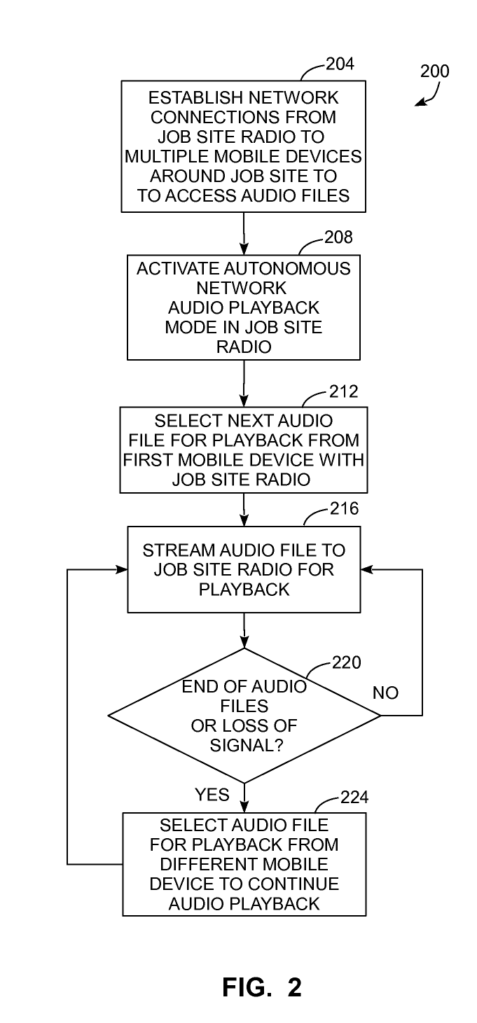

As described above, the job site radio 104 is configured to receive audio data from a mobile device 136 on the job site using the wireless network transceiver 108. FIG. 2 depicts a process 200 for automated playback of audio files that are stored in mobile devices around the job site through the job site radio 104. In the process 200, the job site radio 104 selects audio files for playback and streams the audio data from the mobile devices in an automated manner to provide playback of music or other sound files with minimal requirements for interaction from workers at the job site. In the discussion below, a reference to the process 200 performing a function or action refers to a processor, such as the controller 124 or a processor in a mobile device, executing stored program instructions to perform the function or action. The process 200 is described in conjunction with the system 100 of FIG. 1 for illustrative purposes.

Process 200 begins as one or more mobile devices grant the job site radio access to audio files that are stored in memory in the mobile devices (block 204). In one embodiment, the access process includes a network access stage to enable communication between the mobile devices 136 and the job site radio 104, and a media permission access stage where operators of the mobile devices 136 grant access to one or more audio files for playback through the job site radio 104. For example, in the system 100, the wireless network transceiver 108 in the job site radio 108 is a Bluetooth transceiver, and the job site radio 104 is granted wireless access to the mobile devices 136 through a pairing process with corresponding Bluetooth transceivers in the mobile devices 136. In another embodiment, the job site radio 104 acts as a wireless base station or access point and the mobile devices 136 establish wireless connections with the job site radio 104 using passphrases, cryptographic keys, or other login credentials to establish the wireless connections. To perform the media permission access stage, each of the mobile electronic devices 136 executes a software application that identifies stored audio files held in a memory formed by one more data storage devices that are associated with the mobile electronic device. The user selects audio files that are available for playback through the job site radio 104. The software application enables the user to select large groups of related audio files easily, such as by musical group, album, genre, etc.

During process 200, the access procedure is optionally performed when a mobile device first accesses a job site radio, and does not need to be performed repeatedly to enable automated playback of audio files stored on a mobile device. For example, during a two-week job a mobile device 136 is registered once with the job site radio 104, but the job site radio 104 continues to have access to the audio files in the mobile device 136 when the mobile device 136 is present at the job site without requiring additional action by the user.

Process 200 continues when the job site radio enters an autonomous network audio playback mode (block 208). In the autonomous network audio playback mode, the job site radio 104 identifies one or more of the mobile network devices 136 that are accessible through the wireless network transceiver 108. During the course of operation, the number of available mobile devices 136 changes as workers carry mobile devices on and off the job site, and the job site radio 104 monitors the availability of the mobile devices. The autonomous network audio playback mode is activated through a command sent from one of the mobile devices 136 or through a control interface that is integrated with the job sit radio 104.

Process 200 continues as the controller 124 in the job site radio 104 selects the next audio file in the playback list for playback from one of the mobile devices 136 that is accessible through the wireless network interface 108 (block 212). In one embodiment, the job site radio 104 requests audio files from one or more of the mobile devices 136 in a randomized manner, or the job site radio 104 requests audio files in a predetermined order based on a playlist or other sorting technique. The wireless network transceiver 108 in the job site radio 104 receives a stream of the data in the requested audio file from the mobile device 136, and the controller 124 generates an audio output through the audio output speakers 132 (block 216). In one embodiment, the job site radio 104 buffers a portion of the audio data in memory to enable continuous playback. The job site radio 104 does not, however, store the audio data after completion of the playback. Thus, in the system 100 the job site radio 104 does not require large internal data storage devices to store audio files when the audio files are stored in the mobile devices 136.

Process 200 continues with the streaming of audio data for playback as described with reference to the processing of block 216 until cessation of the audio stream. The cessation typically occurs upon reaching the end of the audio file or if the job site radio 104 is unable to continue streaming the audio file due to a loss of wireless communication between the mobile device 136 and the job site radio 104 (block 220). At the end of playback or when the wireless network connection is lost (block 220), the controller 124 selects another audio file from a different mobile device to continue audio playback (block 224). Process 200 continues as the job site radio 104 plays audio from one or more of the mobile devices 136. The autonomous playback in process 200 enables the job site radio 104 to play back approved music and audio from the mobile devices of one or more workers without requiring the workers to take the time to select songs for playback and control the job site radio 104 manually.

The job site radio 104 is configured to perform the operating modes that are described above separately or in conjunction with one another. For example, one of the mobile devices 136 streams compressed music data to the job site radio 104 and acts as a remote control for the volume and playback of audio from the job site radio 104 in one configuration. The multiple mobile devices can also interact with the job site radio based on a priority structure. For example, a mobile device 136 that belongs to a worker at the job site is registered with the job site radio 104 to stream music and act as a remote control for the radio. Another one of the job site radios that belongs to a supervisor at the job site is registered with the job site radio 104 with additional permission to act as an input source for the loudspeaker functionality in the job site radio. If the job site radio 104 receives conflicting commands from the two mobile devices, then the controller 124 performs the command from the mobile device 136 of the supervisor that is assigned a higher priority level. As used herein, the term “conflicting command” refers to any command is any command that changes the operation of the job site radio to halt a previously selected mode of operation. For example, changing the playback audio file, activating the loudspeaker mode instead of playing music are examples of conflicting commands. In some embodiments, an administrator mobile device selects operational commands that are considered “conflicting” commands so, for example, a command that changes the output volume level for the output speakers 132 may be considered a conflicting command in one operating configuration but a non-conflicting command in another configuration.

The controller 124 identifies the priority level based on the hardware network addresses of the multiple network devices 136 that transmit commands to the job site radio 104. The controller 124 stores the hardware address data in the memory during the initial registration process, and associates the hardware addresses with different priority levels that are assigned during the registration process. Thus, a command from one of the mobile devices 136 that is associated with a supervisor at the job site supersedes another command from another mobile device that is associated with a worker at the job site.

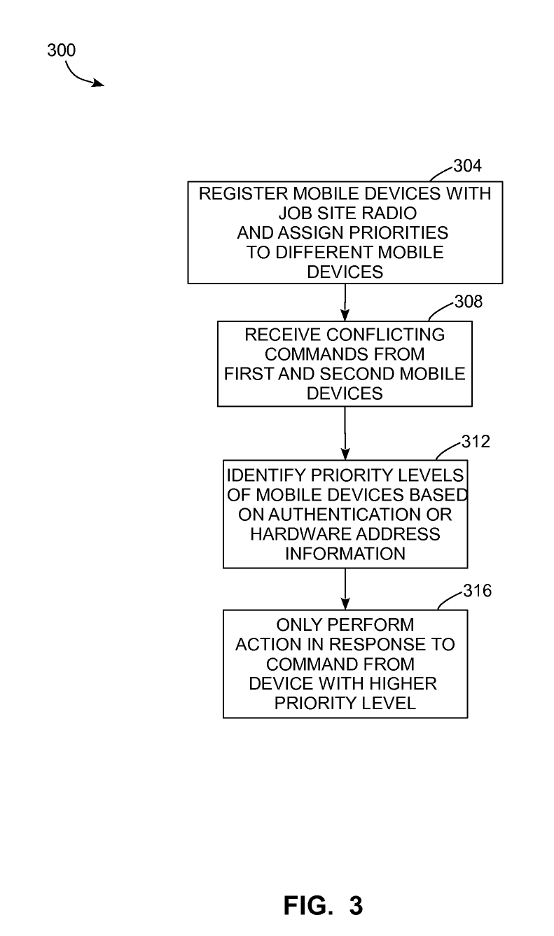

FIG. 3 depicts a process 300 for operating an audio playback device, such as a job site radio, using multiple mobile electronic devices that are configured with different priority levels. In the discussion below, a reference to the process 300 performing a function or action refers to a processor, such as the controller 124 or a processor in a mobile device, executing stored program instructions to perform the function or action. The process 300 is described in conjunction with the system 100 of FIG. 1 for illustrative purposes.

Process 300 begins with a registration and priority level assignment processes between the audio playback device and two or more mobile electronic devices (block 304). The registration process optionally includes a pairing process, such as Bluetooth device pairing, or another process during which the job site radio 104 receives registration information from one of the mobile devices 136 through the wireless network transceiver 108. The registration data include a hardware address identifier that is associated with the physical hardware in the mobile electronic device, such as a media access control (MAC) address, unique hardware device serial number, or other suitable hardware address information. The hardware address information for the mobile device 136 does not typically change during operation of the mobile device. In some embodiments, the registration data also include a username and password or cryptographic token that the job site radio 104 uses to identify the user of a device instead of or in addition to the hardware address that is associated with the mobile device. In the radio 104, the controller 124 stores the registration data for each of the registered mobile devices 136 in a memory to identify the mobile devices during operation of the job site radio 104.

The registration process also assigns priority levels to each of the registered mobile devices 136. In one configuration, the party who owns or controls the job site radio 104 registers a mobile device with a highest level of privileges that override the privileges of other registered devices. The mobile device with the highest level of privileges is referred to as an “administrative device” for explanatory purposes herein. For example, a supervisor at a job site can use the administrative mobile device 136 to prevent other mobile devices 136 from accessing the job site radio 104 as a loudspeaker, but the other mobile devices 136 may retain limited access such as having the ability to tune a different radio station or update playlists for music. The administrative mobile device 136 can be used to add or remove privileges from the remaining registered mobile devices to adjust the control priority levels of different mobile devices in the system 100.

In some situations, the job site radio 104 accepts commands from different mobile devices. For example, the administrative mobile device 136 may generate a playback command for the job site radio 104 to generate an audio output of a music playlist that is stored in the memories one or more of the mobile devices 136. One of the mobile devices with a lower privilege level may send commands to raise or lower the volume of the audio output during operation without conflict. In some instances, the job site radio 104 receives conflicting commands from two different mobile devices 136 that are assigned equal priority levels. In two different configurations, the job site radio 104 either performs the action from the most recently received command or ignores new commands until completing an action, such as completing playback of an audio file.

During process 300 the job site radio 104 may receive conflicting commands from two different mobile devices that have two different priority levels (block 308). For example, the job site radio 104 may receive a command from another one of the mobile devices 136 that selects different music from the music on the play list that the job site radio 104 receives from the administrator device 136. The job site radio 104 can receive the conflicting commands from the two mobile devices 136 in any order.

To resolve the conflicting commands, the controller 124 identifies the priority levels of both the first mobile device and second mobile device that submitted the conflicting commands (block 312). In one embodiment, the controller 124 identifies the unique hardware address identifiers or user credentials for the two mobile devices and retrieves the corresponding device priority levels that were generated during the registration process from memory. The controller 124 ignores the command that is received from the mobile device with the lower priority level and either continues to operate in accordance with the command from the higher priority device, or changes operation to perform the command from the higher priority mobile device instead of the command from the lower priority device (block 316). The job site radio 104 optionally transmits an error message to the lower-priority mobile device 136 to inform the user that the transmitted command will not be executed due to a priority conflict.

It will be appreciated that variants of the above-described and other features and functions, or alternatives thereof, may be desirably combined into many other different systems, applications or methods. Additional information pertaining to this patent is included in the attached appendix, which is expressly incorporated herein in its entirety. Various presently unforeseen or unanticipated alternatives, modifications, variations or improvements may be subsequently made by those skilled in the art that are also intended to be encompassed by the embodiments disclosed herein and as set forth in the following claims.

What is claimed:

1. A method of operating an audio playback device comprising:
establishing with a wireless network transceiver in the audio playback device, a wireless network connection between the audio playback device and one mobile device in a plurality of mobile devices;
receiving with the wireless network transceiver in the audio playback device a stream of data from a requested audio file stored in a memory of the one mobile device;
generating with an audio output device in the audio playback device an audio output corresponding to the stream of data from the audio file;
establishing with the wireless network transceiver in the audio playback device, another wireless network connection between the audio playback device and another mobile device in the plurality of mobile devices in response to a cessation of the stream of data from the audio file;
receiving with the wireless network transceiver in the audio playback device another stream of data from another requested audio file stored in another memory of the other mobile device; and
generating with the audio output device another audio output corresponding to the other stream of data from the other audio file.

2. The method of claim 1, the establishment of the other wireless network connection between the audio playback device and the other mobile device occurring in response to a completion of the stream of data for the audio file.

3. The method of claim 1, the establishment of the other wireless network connection between the audio playback device and the other mobile device occurring in response to a loss of the wireless network connection between the audio playback device and the one mobile device.

4. The method of claim 1 further comprising:
generating with the one mobile device the requested audio file with reference to audio data received from a microphone in the one mobile device; and
receiving with the wireless network transceiver in the audio playback device the stream of data from the requested audio file to enable the audio playback device to generate an audio output corresponding to the audio data received from the microphone in the one mobile device.

5. A method of operating an audio playback device comprising:
receiving with a wireless network transceiver in the audio playback device a first command from a first mobile device;
receiving with the wireless network transceiver in the audio playback device a second command from a second mobile device;
identifying with a controller in the audio playback device a first priority level of the first mobile device and a second priority level of the second mobile device;
operating with a controller the audio playback device with reference to only the first command in response to the first priority level of the first mobile device exceeding the second priority level of the second mobile device; and
operating with the controller the audio playback device with reference to only the second command in response to the second priority level of the second mobile device exceeding the first priority level of the first mobile device.

6. The method of claim 5 further comprising:
receiving first registration data from the first mobile device with the wireless network transceiver in the audio playback device prior to receiving the first command and second command;
receiving second registration data from the second mobile device with the wireless network transceiver in the audio playback device prior to receiving the first command and the second command;
storing with the controller the first registration data in a memory in association with the first priority level prior to receiving the first command and the second command; and
storing with the controller the second registration data in the memory in association with the second priority level prior to receiving the first command and the second command.

7. The method of claim 6, the identification of the first priority level further comprising:
identifying with the controller a first hardware address associated with the first mobile device in the first command; and
identifying with the controller the first priority level for the first mobile device with reference to the first hardware address of the first mobile device in the first registration data stored in the memory.

8. The method of claim 7, the identification of the second priority level further comprising:
identifying with the controller a second hardware address associated with the first mobile device in the second command; and
identifying with the controller the second priority level for the second mobile device with reference to the second hardware address of the second mobile device in the second registration data stored in the memory.

9. An audio playback device comprising:
a wireless network transceiver configured to establish wireless network connections with a plurality of mobile devices;
an audio output device;
a memory; and
a controller operatively connected to the wireless network transceiver, the audio output device, and the memory, the controller being configured to:
establish a wireless network connection between the audio playback device and one mobile device in the plurality of mobile devices with the wireless network transceiver;
receive in the audio playback device a stream of data from a requested audio file stored in a memory of the one mobile device with the wireless network transceiver;
generate an audio output corresponding to the stream of data from the audio file with the audio output device;
establish another wireless network connection between the audio playback device and another mobile device in the plurality of mobile devices in response to a cessation of the stream of data from the audio file with the wireless network transceiver;
receive another stream of data from another requested audio file stored in another memory of the other mobile device with the wireless network transceiver; and
generate another audio output corresponding to the other stream of data from the other audio file with the audio output device.

10. The audio playback device of claim 9, the controller being further configured to:
establish the other wireless network connection between the audio playback device and the other mobile device in response to a completion of the stream of data for the audio file.

11. The audio playback device of claim 9, the controller being further configured to:
establish the other wireless network connection between the audio playback device and the other mobile device in response to a loss of the wireless network connection between the audio playback device and the one mobile device.

12. The audio playback device of claim 9, the controller being further configured to:
receive a first command from a first mobile device in the plurality of mobile devices with a wireless network transceiver;
receive a second command from a second mobile device in the plurality of mobile devices with the wireless network transceiver;
identify a first priority level of the first mobile device and a second priority level of the second mobile device;
operate the audio playback device with reference to only the first command in response to the first priority level of the first mobile device exceeding the second priority level of the second mobile device; and
operate the audio playback device with reference to only the second command in response to the second priority level of the second mobile device exceeding the first priority level of the first mobile device.

13. The audio playback device of claim 12, the controller being further configured to:
receive first registration data from the first mobile device with the wireless network transceiver prior to receiving the first command and second command;
receive second registration data from the second mobile device with the wireless network transceiver prior to receiving the first command and the second command;
store the first registration data in the memory in association with the first priority level prior to receiving the first command and the second command; and
store the second registration data in the memory in association with the second priority level prior to receiving the first command and the second command.

14. The audio playback device of claim 13, the controller being further configured to:
identify a first hardware address associated with the first mobile device in the first command; and
identify the first priority level for the first mobile device with reference to the first hardware address of the first mobile device in the first registration data stored in the memory.

15. The audio playback device of claim 14, the controller being further configured to:
identify a second hardware address associated with the first mobile device in the second command; and
identify the second priority level for the second mobile device with reference to the second hardware address of the second mobile device in the second registration data stored in the memory.

16. The audio playback device of claim 9 wherein the audio output device further comprises loudspeakers.
